(19) United States
(12) Patent Application Publication
(10) Pub. No.: US 2015/0170857 A1
(43) Pub. Date: Jun. 18, 2015

(54) ELECTROMAGNETIC ACTUATOR FOR A MEDIUM VOLTAGE VACUUM CIRCUIT BREAKER

(71) Applicant: ABB TECHNOLOGY AG, Zurich (CH)

(72) Inventor: Christian REUBER, Willich (DE)

(73) Assignee: ABB TECHNOLOGY AG, Zurich (CH)

(21) Appl. No.: 14/633,679

(22) Filed: Feb. 27, 2015

Related U.S. Application Data
(63) Continuation of application No. PCT/EP2013/002562, filed on Aug. 26, 2013.

(30) Foreign Application Priority Data
Aug. 27, 2012 (EP) 12006073.6

(51) Int. Cl. H01H 33/666; H01H 50/20

(52) U.S. Cl. CPC H01H 33/666; H01H 50/20

(57) ABSTRACT

A electromagnetic actuator is disclosed for a medium voltage vacuum circuit breaker, having at least one movable ferromagnetic plunger which is guided by at least one axis in a ferromagnetic frame. At least one permanent magnet can be arranged on an inner extent area of the ferromagnetic frame, and at least one coil can be at least partially arranged inside the ferromagnetic frame. The at least one permanent magnet can be extended perpendicular to the at least one axis in the coil overhang area.

### RELATED APPLICATION

This application claims priority as a continuation application under 35 U.S.C. §120 to PCT/EP2013/002562, which was filed as an International Application on Aug. 26, 2013 designating the U.S., and which claims priority to European Application 12006073.6 filed in Europe on Aug. 27, 2012. The entire contents of these applications are hereby incorporated by reference in their entireties.

### FIELD

A electromagnetic actuator is disclosed for a medium voltage vacuum circuit breaker, having, for example, at least one movable ferromagnetic plunger which is guided by at least one axis in a ferromagnetic frame, wherein at least one permanent magnet is arranged on an inner extent area of the ferromagnetic frame, and wherein at least one coil is at least partially arranged inside the ferromagnetic frame.

Furthermore, a vacuum circuit breaker is disclosed for medium voltage applications having at least one such electromagnetic actuator.

### BACKGROUND INFORMATION

Known electromagnetic actuators are integrated in a medium voltage to high voltage circuit breaker. For example, medium voltage circuit breakers are rated between 1 kV and 72 kV of a high current level. These specific breakers interrupt the current by creating and extinguishing the arc in a vacuum container. Inside the vacuum container a pair of corresponding electrical switching contacts can be accommodated. Modern vacuum circuit breakers can have a longer life expectancy than former air circuit breakers. Although, vacuum circuit breakers can replace air circuit breakers, the present disclosure is not only applicable to vacuum circuit breakers but also to, for example, air circuit breakers or modern SF6 circuit breakers having a chamber filled with sulfur hexafluoride gas instead of vacuum.

For actuating a circuit breaker, a bistable electromagnetic actuator with a high force density can be used which moves one of the electrical contacts of a vacuum interrupter for a purpose of electrical power interruption. Therefore, a mechanical connection between a movable armature of the electromagnetic actuator and an axially movable electrical contact inside the vacuum interrupter can be provided.

A relevant design parameter for the performance of a vacuum circuit breaker is the force that presses the contacts of the vacuum interrupters against each other. To balance this force with an electromagnetic actuator, the static holding force of the actuator must be sufficiently high.

EP 0 721 650 B1 discloses a bistable permanent magnet actuator which includes a magnetic yoke having a laminated structure at least one permanent magnet and an armature axially reciprocable in a first direction within the yoke. The actuator is configured to provide a first low reluctance flux path and a first high reluctance flux path when the armature is in a first position. Furthermore, the actuator is configured to provide a second low reluctance flux path and a second high reluctance flux path when the armature is in a second position. Means are arranged for driving the armature between the first and second position. Each lamination of the yoke defines a plane in which a portion of the permanent magnet and the armature reside, and wherein the configuration of the actuator thereby enables an increase in the permanent magnet flux flowing through the actuator by the addition of further yoke laminations and a corresponding increase in the linear dimension of the magnet and armature in a second direction perpendicular to the plane of the laminations.

DE 101 46 899 A1 discloses a bistable electromagnetic actuator which is in particular a drive for a vacuum interrupter chamber. The bistable electromagnetic actuator includes a yoke, at least one permanent magnet, at least one coil and at least one displaceable armature. A first magnetic flux is generated by the armature. The yoke is such that the armature is held in one position and the coil generates a second magnetic flux that actuates the armature. The permanent magnet is located between the yoke and a fixed magnetic return element, in such a way that magnetic fluxes run via the magnetic return element. In addition, the armature outside the yoke at least partially covers a front face of the yoke, wherein the face runs perpendicularly to the direction of displacement of the armature.

EP 1 843 375 A1 discloses an electromagnetic actuator, such as for a medium voltage switch, including a magnet core having a coil and a movable yoke, wherein the magnet core of the electromagnetic actuator is rectangular and the movable yoke is a round yoke which corresponds to a magnetic circuit of the magnetic core. The electromagnetic actuator is placed directly under a vacuum switching chamber of a medium voltage switch such that the electromagnetic actuator is free from leverage and from deflection and acts directly on a contact rod of the medium voltage switch.

### SUMMARY

An electromagnetic actuator for a medium voltage vacuum circuit breaker, is disclosed, comprising: at least one movable ferromagnetic plunger which is guided by at least one axis in a ferromagnetic frame; at least one permanent magnet arranged on an inner extent area of the ferromagnetic frame; and at least one coil at least partially arranged inside the ferromagnetic frame, the least one permanent magnet being extended perpendicular to the at least one axis in at least one coil overhang area (A).

### BRIEF DESCRIPTION OF THE DRAWINGS

The foregoing and other aspects disclosed herein will become apparent following the detailed description of exemplary embodiments, when considered in conjunction with the enclosed drawings, wherein:

FIG. 1 shows a schematic longitudinal cut through a medium voltage vacuum circuit breaker operated by a single electromagnetic actuator via a jackshaft arrangement according to an exemplary embodiment disclosed herein;

FIG. 2 is a perspective view of the exemplary electromagnetic actuator with two coils shown in FIG. 1 with an additional detailed view of the flux guidance pieces; and

FIG. 3 is a perspective view of the exemplary electromagnetic actuator with one coil according to an exemplary embodiment of the invention with an additional detailed view of the flux guidance pieces.

The reference symbols used in the drawings, and their meanings, are listed in summary form in the list of reference symbols.

### DETAILED DESCRIPTION

An electromagnetic actuator is disclosed with a reduced thickness of a permanent magnet without a loss of static holding force of the permanent magnet.

According to an exemplary embodiment, the at least one permanent magnet is extended perpendicular to the at least one axis in a coil overhang area. This design of the at least one permanent magnet can be improved regarding the required amount of permanent magnetic material, which can be expensive because it includes precious and rare alloying elements. Permanent magnetic material can be used in a more effective way by reducing its thickness, wherein this relates to a reduction of the static holding force.

This relative reduction of the static holding force is however lower than the relative reduction of the thickness or amount of magnetic material used. As an example, a reduction of the thickness of the permanent magnets in a state-of-the-art actuator by 20% can result in a reduction of static holding force of only 10%. To make it possible to use thinner permanent magnets, it can be desirable to compensate the loss of static holding force by extending only the area of the permanent magnets, not the entire two-dimensional shape, further into the third direction. The extension of the at least one permanent magnet into the third dimension will certainly increase the required amount of permanent magnetic material, but the reduction of the thickness will result in a stronger reduction of the amount. The reduced thickness has an over-proportional effect, regarding the reduction of the amount of permanent magnetic material, while the additional extension into the third dimension has only a proportional effect. This extension can be advantageous because it will not increase the total dimension of the electromagnetic actuator, as the required room is already available between the winding overhang of the coils of the electromagnetic actuator.

In an exemplary embodiment, at least one flux guidance piece has a triangular shaped cross-section and is arranged with one surface at the at least one permanent magnet and with another surface at the ferromagnetic frame for connecting the extended part of the at least one permanent magnet with the ferromagnetic frame. The at least one flux guidance piece guides the magnetic flux into the magnetic circuit and can be an integral part of the ferromagnetic frame, or it can be realised as additional, separate part that is being mounted on the ferromagnetic frame.

According to an exemplary embodiment, the at least one flux guidance piece is arranged between the at least one permanent magnet and the at least one movable ferromagnetic plunger.

According to a further exemplary embodiment, the at least one flux guidance piece is arranged between at least two permanent magnets at a girthed area of the ferromagnetic frame.

This arrangement of the at least one flux guidance piece can be advantageous because it will not increase the total dimension of the electromagnetic actuator, as the required room is already available between the winding overhang of the coils of the electromagnetic actuator.

For that, in an exemplary embodiment, the actuator is of a rectangular shape and, the at least one permanent magnet is wider than the inner opening of the at least one coil (e.g., the magnet extends in the region of the winding heads (or the overhang area) of the at least one coil, such that the total size of the actuator is not increased, and the flux of the at least one permanent magnet is guided with at least one flux guiding piece 8a and/or 8b to the other ferromagnetic parts of the actuator so that the flux is concentrated in an additional way from the sides below the winding heads to the parts that extend through the inner opening of the at least one coil. As such, the volume of permanent magnetic material that is required for a certain value of static holding force of the actuator can be reduced.

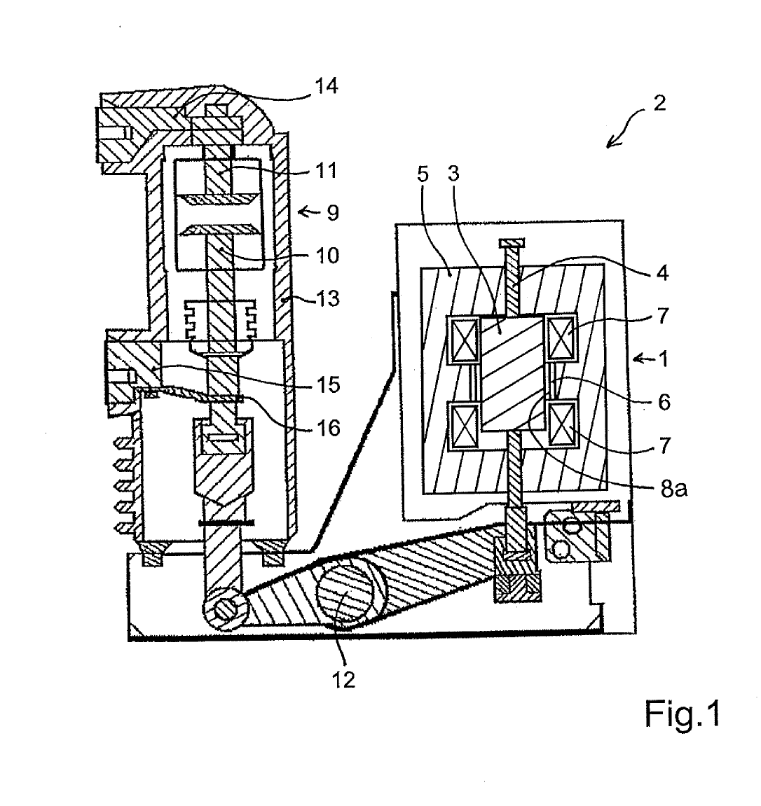

The exemplary medium voltage vacuum circuit breaker 2 as shown in FIG. 1 includes an insulating housing 13 with an embedded upper electrical terminal 14 and a lower electrical terminal 15 forming an electrical switch for medium voltage circuit. Therefore, the upper electrical terminal 14 is connected to a corresponding fixed upper electrical contact 11 which is mounted in a vacuum interrupter 9. A corresponding movable lower electrical contact 10 is movable mounted in relation to the vacuum interrupter 9. The lower electrical terminal 15 is connected to the corresponding movable lower electrical contact 10. The movable lower electrical contact 10 is movable between a closed and opened switching position via a jackshaft arrangement 12.

A flexible conductor 16 of copper material is provided in order to electrically connect the lower electrical terminal 15 with the movable lower electrical contact 10. The jackshaft arrangement 12 internally couples the mechanical energy of a bistable electromagnetic actuator 1 to the insulating housing 13 of the vacuum interrupter 9. The bistable electromagnetic actuator 1 includes (e.g., consists of) a movable ferromagnetic plunger 3 which is guided by two axes 4 in a ferromagnetic frame 5. Permanent magnets 6 are arranged on an inner extent area of the ferromagnetic frame 5 to create a magnetic flux so that the movable ferromagnetic plunger 3 is tightly being hold in one of the two end positions. Inner flux guidance pieces 8a are arranged between the permanent magnets 6 and the movable ferromagnetic plunger 3. Two coils 7, one at the top and the other at the bottom of the ferromagnetic frame 5, are partially arranged inside the ferromagnetic frame 5 and can be used to modify the magnetic flux in a way that the movable ferromagnetic plunger 3 can move from a top position to a bottom position. The movable ferromagnetic plunger 3 at the top position represents an open position of the medium voltage vacuum circuit breaker 2.

The movable ferromagnetic plunger 3 at the top together with the ferromagnetic frame 5 forms a path of low magnetic resistance for the magnetic fields of the permanent magnets 6. In contrast, the gap at the bottom of the movable ferromagnetic plunger 3 represents a high magnetic resistance for the magnetic fields of the permanent magnets 6. Therefore, the magnetic field lines run almost exclusively through the top of the movable ferromagnetic plunger 3 because of the connection with the ferromagnetic frame 5. The permanent magnets 6 produce a lag attracting force which is transmitted via the jackshaft arrangement 12 onto the movable lower electrical contact 10 of the vacuum interrupter 9.

The two coils 7 are used for switching, wherein the additional magnetic energy of the bottom coil 7 compensates for the high magnetic resistance of the gap, directing the magnetic field lines towards the bottom of the movable ferromagnetic plunger 3. The retaining force at the top of the movable ferromagnetic plunger 3 declines, while the attracting force at the bottom of the movable ferromagnetic plunger 3 increases. When a certain level of current in the bottom coil 7 is exceeded, the movable ferromagnetic plunger 3 starts to move to the bottom. When the final position of the movable ferromagnetic plunger 3 is reached, the remaining current in the bottom coil 7 can improve the latching process. Current in the bottom coil 7 is not required, as long as the medium voltage vacuum circuit breaker 2 stays in a closed position. The medium voltage vacuum circuit breaker 2 can be opened by switching on the top coil current, wherein the movable ferromagnetic plunger 3 moves to the top position.

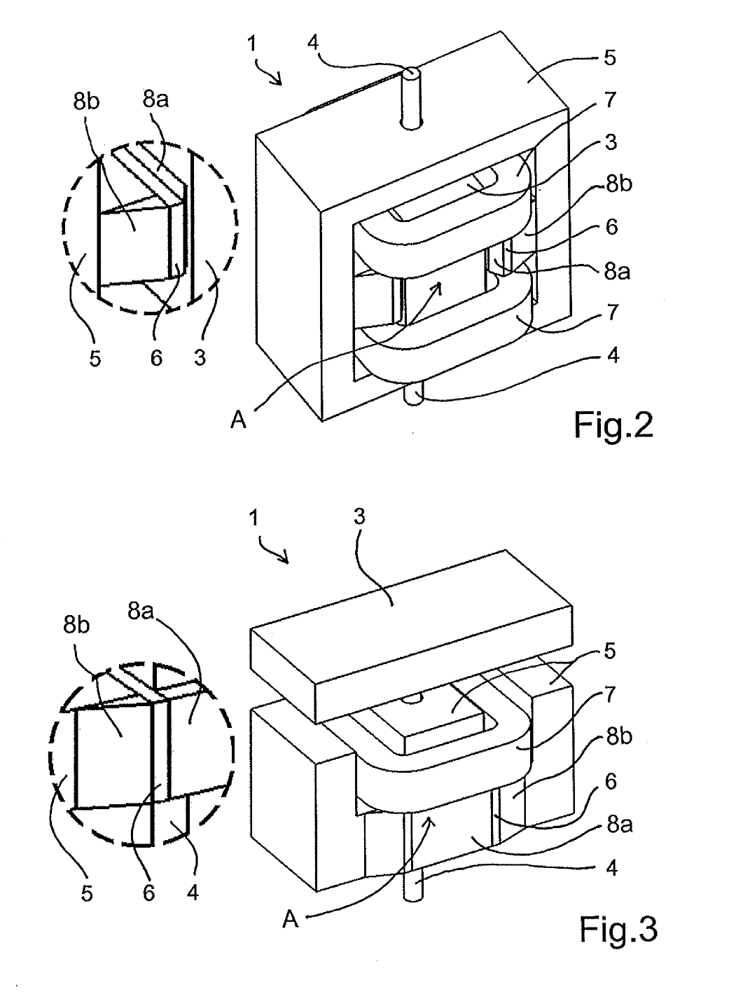

FIG. 2 shows a perspective view of the exemplary bistable electromagnetic actuator 1 with two coils 7 shown in FIG. 1, wherein an additional detailed view of the flux guidance pieces 8a and 8b should improve the understanding. The movable ferromagnetic plunger 3 is guided by two axes 4 in the ferromagnetic frame 5, wherein the ferromagnetic frame 5 is partially surrounding the movable ferromagnetic plunger 3. Furthermore, the two coils 7 are surrounding the movable ferromagnetic plunger 3. The permanent magnets 6 are extended perpendicular to the axes 4 in the coil overhang area A. This extension can be at one side of the actuator, or at both sides, i.e., also at the opposite coil overhang area. This extension can also be asymmetric (i.e., it can be larger in one coil overhang area than in the opposition coil overhang area). Two inner flux guidance pieces 8a (the visible one and—in this example the opposing one that is at the other side of the actuator and not visible in this figure) are arranged between each of the permanent magnets 6 and the movable ferromagnetic plunger 3 for collecting the flux of the extended permanent magnets 6 and for directing this flux into the plunger 3. Four exemplary outer flux guidance pieces 8b have a triangular shaped cross-section and are arranged with one surface at the permanent magnet 6 and with another surface at the ferromagnetic frame 5 for connecting, both mechanically and magnetically, the extended part of the at least one permanent magnet 6 with the ferromagnetic frame 5.

FIG. 3 is a perspective view of the electromagnetic actuator 1 with one coil 7 according to a further exemplary embodiment, wherein an additional detailed view of the flux guidance pieces 8a and 8b can improve the understanding. The movable ferromagnetic plunger 3 is guided by the axis 4 in the ferromagnetic frame 5. The coil 7 is being used to modify the magnetic flux in a way that the movable ferromagnetic plunger 3 can move from a position away from the ferromagnetic frame 5 towards the ferromagnetic frame 5.

For the closing operation, the current in the coil 7 is directed in a way to increase the magnetic flux of the permanent magnets 6. In the closed position, an opening spring can also be energised by the electromagnetic actuator 1. For opening the electromagnetic actuator 1, the coil 7 is to be fed with a current in a reversed direction, so that the magnetic flux of the permanent magnets 6 is decreased. The reduced holding force of the electromagnetic actuator 1 will no longer be sufficient to hold the external forces, from the load and from the opening spring, so that the electromagnetic actuator 1 will open. The inner flux guidance pieces 8a (the visible one and—in this example—the opposing one that is at the outer side of the actuator and not visible in this figure) are arranged between two permanent magnets 6 and attached to the sides of the central part of the ferromagnetic frame 5 at a girthed area of the ferromagnetic frame 5. Four outer flux guidance pieces 8b have a triangular shaped cross-section and are arranged with one surface at the permanent magnet 6 and with another surface at the ferromagnetic frame 5 for connecting, both mechanically and magnetically, the extended part of the at least one permanent magnet 6 with the ferromagnetic frame 5.

While exemplary embodiments have been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims. For example, the flux guidance pieces 8a and 8b which are arranged at the ferromagnetic frame 5 may be an integral part of the ferromagnetic frame 5, and they also may have a rectangular shape.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE SIGNS

1 electromagnetic actuator
2 circuit breaker
3 movable ferromagnetic plunger
4 axis
5 ferromagnetic frame
6 permanent magnet
7 coil
8a inner flux guidance piece
8b outer flux guidance piece
9 vacuum interrupter
10 movable lower electrical contact
11 fixed upper electrical contact
12 jackshaft arrangement
13 insulating housing
14 upper electrical terminal
15 lower electrical terminal
16 flexible conductor
A coil overhang area

1. An electromagnetic actuator for a medium voltage vacuum circuit breaker, comprising:
at least one movable ferromagnetic plunger which is guided by at least one axis in a ferromagnetic frame;
at least one permanent magnet arranged on an inner extent area of the ferromagnetic frame; and
at least one coil at least partially arranged inside the ferromagnetic frame, the least one permanent magnet being extended perpendicular to the at least one axis in at least one coil overhang area (A).

2. Electromagnetic actuator of claim 1, comprising:
at least one inner flux guidance piece arranged between the at least one permanent magnet and the at least one movable ferromagnetic plunger.

3. Electromagnetic actuator of claim 1, wherein the at least one movable ferromagnetic plunger is guided by at least one axis in a ferromagnetic frame, wherein the ferromagnetic frame partially surrounds the at least one movable ferromagnetic plunger.

4. Electromagnetic actuator of claim 2, wherein the at least one inner flux guidance piece is arranged between at least two permanent magnets at a girthed area of the ferromagnetic frame.

5. Electromagnetic actuator of claim 1, comprising:
at least one outer flux guidance piece having a triangular or rectangular shaped cross-section, arranged with one surface at the at least one permanent magnet and with another surface at the ferromagnetic frame for connecting an extended part of the at least one permanent magnet with the ferromagnetic frame.

6. Electromagnetic actuator of claim 2, wherein the at least one inner flux guidance piece is an integral part of the ferromagnetic frame.

7. Electromagnetic actuator of claim 2, wherein the at least one inner flux guidance piece is a separate part of the ferromagnetic frame, which is mountable on the ferromagnetic frame.

8. Electromagnetic actuator of claim 1, wherein the at least one movable ferromagnetic plunger and/or the ferromagnetic frame are rectangular shaped.

9. Electromagnetic actuator of claim 1, wherein:
the actuator is of a rectangular shape;
the at least one permanent magnet is wider than an inner opening of the at least one coil in a region of winding heads; and
a flux of the at least one permanent magnet is guided with at least one flux guiding piece to the ferromagnetic plunger and/or frame of the actuator so that flux will be concentrated from sides below the winding heads to parts that extend through the inner opening of the at least one coil in such a manner that a volume of permanent magnetic material for a certain value of static holding force of the actuator can be reduced relative to a configuration absent the at least one flux guiding piece.

10. A medium voltage vacuum circuit breaker, comprising:
a vacuum interrupter having a movable lower electrical contact and a fixed upper electrical contact;
an electromagnetic actuator of claim 1 for generating an operation force; and
a jackshaft arrangement for the operation force to the vacuum interrupter.

11. Electromagnetic actuator of claim 5, wherein the at least one outer flux guidance piece is an integral part of the ferromagnetic frame.

12. Electromagnetic actuator of claim 7, wherein the at least one outer flux guidance piece is a separate part of the ferromagnetic frame, which is mountable on the ferromagnetic frame.

13. Electromagnetic actuator of claim 9, wherein the at least one permanent magnet extends in a region of winding heads of the at least one coil and does not increase a total size dimension of the electromagnetic actuator.

14. Electromagnetic actuator of claim 2, wherein the at least one movable ferromagnetic plunger is guided by at least one axis in a ferromagnetic frame, wherein the ferromagnetic frame partially surrounds the at least one movable ferromagnetic plunger.

15. Electromagnetic actuator of claim 14, wherein the at least one inner flux guidance piece is arranged between at least two permanent magnets at a girthed area of the ferromagnetic frame.

16. Electromagnetic actuator of claim 15, wherein the at least one inner flux guidance piece is an integral part of the ferromagnetic frame.

17. Electromagnetic actuator of claim 16, wherein the at least one movable ferromagnetic plunger and/or the ferromagnetic frame are rectangular shaped.

18. Electromagnetic actuator of claim 17, wherein:
the actuator is of a rectangular shape;
the at least one permanent magnet is wider than an inner opening of the at least one coil in a region of winding heads; and
a flux of the at least one permanent magnet is guided with at least one flux guiding piece to the ferromagnetic plunger and/or frame of the actuator so that flux will be concentrated from sides below the winding heads to parts that extend through the inner opening of the at least one coil in such a manner that a volume of permanent magnetic material for a certain value of static holding force of the actuator can be reduced relative to a configuration absent the at least one flux guiding piece.

19. A medium voltage vacuum circuit breaker, comprising:
a vacuum interrupter having a movable lower electrical contact and a fixed upper electrical contact;
an electromagnetic actuator of claim 18 for generating an operation force; and
a jackshaft arrangement for the operation force to the vacuum interrupter.
